(19) United States
(12) Patent Application Publication
(10) Pub. No.: US 2002/0147672 A1
(43) Pub. Date: Oct. 10, 2002

(54) Data-processing method and system for establishing a personalized ranking of financial investment products for an investor

(75) Inventor: Francesco Maria Gaini, Milano (IT)

Correspondence Address: KALOW & SPRINGUT LLP, 488 MADISON AVENUE, 19TH FLOOR, NEW YORK, NY, 10022, US

(73) Assignee: Fundsworld Financial Services Limited, Dublin (IE)

(21) Appl. No.: 10/102,419

(22) Filed: Mar. 18, 2002

Related U.S. Application Data
(63) Continuation of application No. PCT/IB00/00986, filed on Jul. 18, 2000.

(51) Int. Cl. G06F 17/60

(52) U.S. Cl. 705/36

(57) ABSTRACT

The present invention comprises a method of establishing a personalized ranking of financial investment products for an investor. The invention also comprises a method of establishing a personalized composition of a portfolio of shares in mutual funds for an investor. The invention further comprises an interactive model of establishing a personalized ranking of financial investment products for an investor within a telecommunication network architecture of the client-server type, and an interactive method of establishing a personalized composition of a portfolio of shares in mutual funds for an investor within a telecommunication network architecture of the client-server type. The invention also comprises a computer program which can be loaded directly into a working memory of a server processing system to implement the steps of the methods of the invention, under the control of the server system when the program is run on the server processing system. The invention also comprises a computer program product comprising a substrate which can be read by a computer, on which substrate the program is stored. It also comprises a program which can be loaded directly into a working memory of a server processing system to implement the steps of the methods of the invention when the program is run on the server processing system. The invention also comprises a data-processing system for establishing a personalized ranking of financial investment products for an investor, as well as a data-processing system for establishing a personalized composition of a portfolio of shares in mutual funds for an investor.

The present invention relates to a data-processing method and system for establishing a personalized ranking of financial investment products for an investor.

The expression “financial investment products” is intended to define mutual funds, stocks and shares, bonds, as well as life policies, loans, etc.

The invention relates, in particular but not exclusively, to a data-processing method and system for establishing such a ranking of financial investment products which can be used, for example, to establish a composition of a portfolio of the said financial investment products, such as a portfolio of shares in mutual funds, personalized for an investor.

As is known, the offer of products and services to the public by means of information networks is experiencing very strong growth. The best known of these information networks is the so-called Internet (“International Network”) to which such a large number of computers, spread throughout the entire world, is now connected that it is known by the epithet “the Net”. On the Internet, computers exchange information with the use of various services, amongst which a place of primary importance is held by the so-called “World Wide Web” (“WWW”). This protocol provides access to so-called web sites.

Amongst the products and services offered on the Internet which are finding great interest with the public are those of a financial nature. By virtue of the offer of such products and services by means of the net, users are able to follow the behaviour of their investments constantly if they wish.

In particular, web sites which enable users subscribing to the service to buy and sell shares on one or even several share markets have already been set up and made accessible.

There are also web sites which enable subscribing users to buy and sell shares in mutual funds.

Some of the above-mentioned web sites also provide subscribing users with tools for establishing a so-called “asset allocation”, that is, a distribution of the user's financial resources over a range of possible financial investment products, for example, stocks or shares in mutual funds.

Till now, however, the offer of products and services of a financial nature on the Net is not yet entirely satisfactory.

The particular nature of these products and services which relate to such an important aspect of an individual's life as his personal or family savings, makes it easy to understand how the offer of these products and services in an impersonal form which, by its nature, the Net is, is destined to failure. In fact, the investor will always feel the need for the advice of a dependable consultant skilled in suggesting personalized investment solutions which take account of a plurality of factors connected with the person concerned.

In particular, currently existing web sites either offer the investor no “advice” of any kind, being limited to allowing the subscribing user of the service to transmit orders for the execution of purchases or sales of stocks or shares in mutual funds on the Net, or they offer an inadequate advice service. In fact, where a service for calculating an asset allocation is provided, it is not adapted at all, or at least is not sufficiently adapted, to the user's particular investor profile.

Moreover, the allocation of assets is established purely at a generic level; for example, in the case of mutual funds, merely a distribution of the user's financial resources amongst the categories of mutual funds (stock funds, balanced funds, bonds, money market funds) or at most amongst specializations within the aforesaid categories (American stock funds, European stock funds, etc.) is produced, without, however, suggesting to the investor which of the commercially available mutual funds to purchase, or is limited to suggesting mutual funds of a particular fund manager with which the supplier of the service has some commercial relationship, without any comparative evaluation with other commercially available mutual funds.

In view of the state of the art described, an object of the present invention is to provide a method of producing a personalized ranking of financial investment products for an investor, particularly but not exclusively for use in order to establish a personalized composition of a portfolio of the said financial investment products, for example, a portfolio of shares in mutual funds.

According to the present invention, this object is achieved by means of the method defined in independent Claims 1, 4, 10 and 13.

The object of the present invention is also to provide a data-processing system suitable for implementing the above-mentioned method.

Again according to the present invention, this further object is achieved by means of the data-processing system defined in independent Claims 23 and 24.

The characteristics and the advantages of the present invention will become clear from a reading of the following detailed description of a preferred embodiment thereof, provided purely by way of non-limiting example, with the aid of the appended drawings, in which:

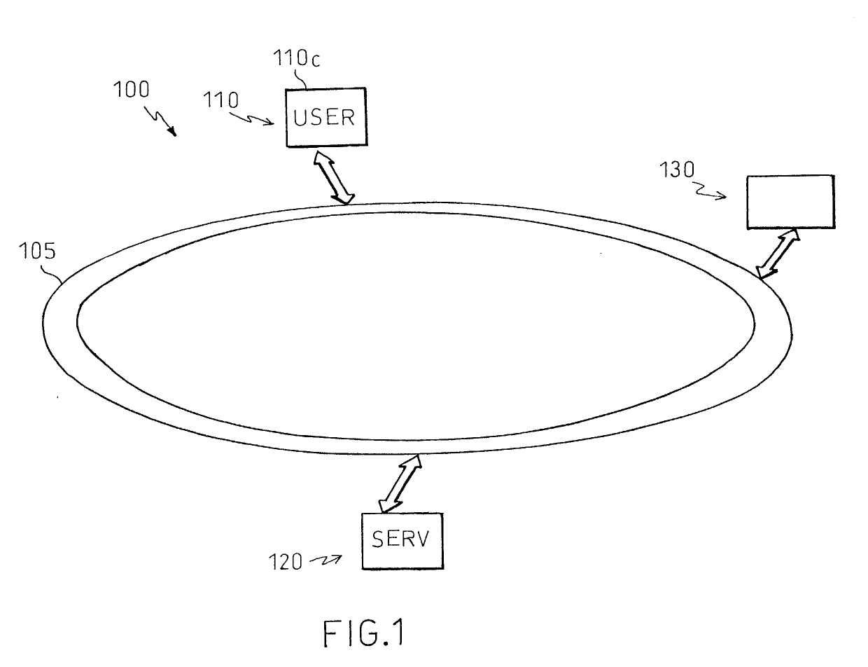

FIG. 1 is a basic diagram of a telecommunication network system in which the method according to the present invention can be used,

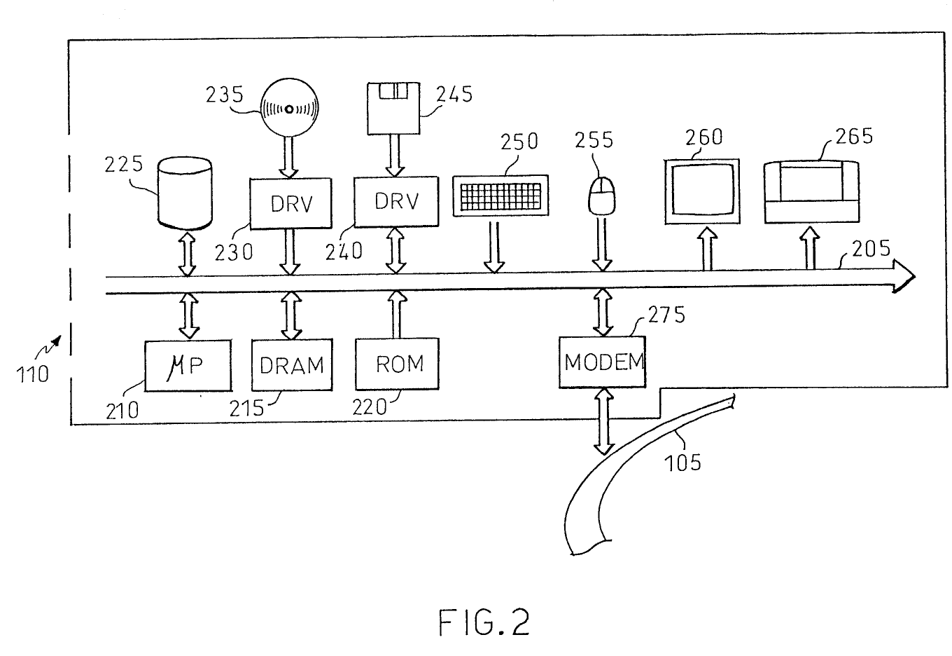

FIG. 2 shows, in schematic form, a user's computer connected to the telecommunication network,

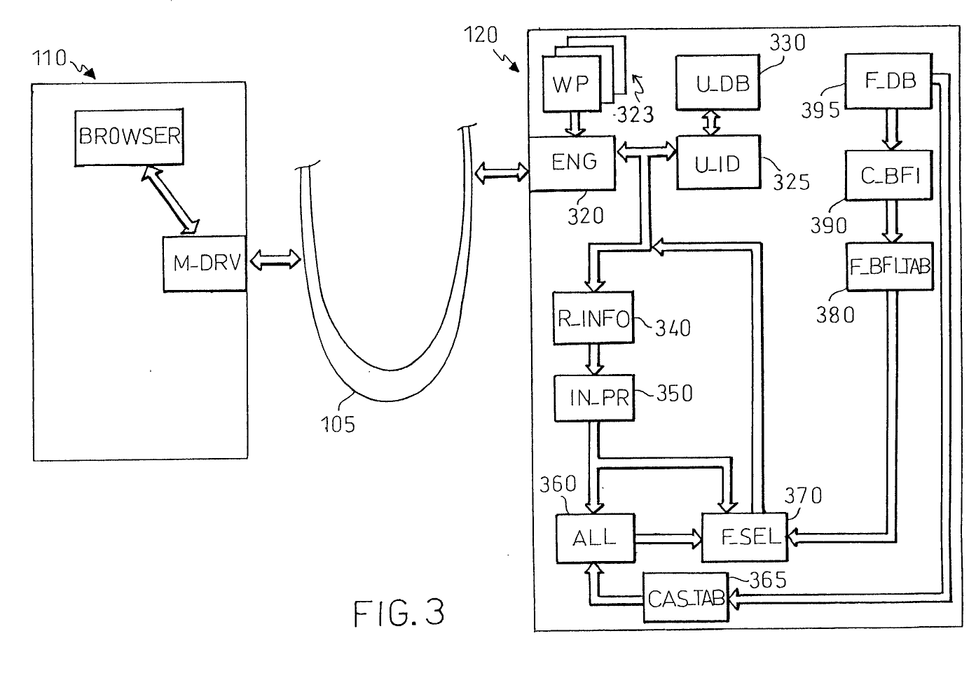

FIG. 3 shows, in schematic form, the content of a working memory of the user's computer and of a service provider's processing system according to the present invention,

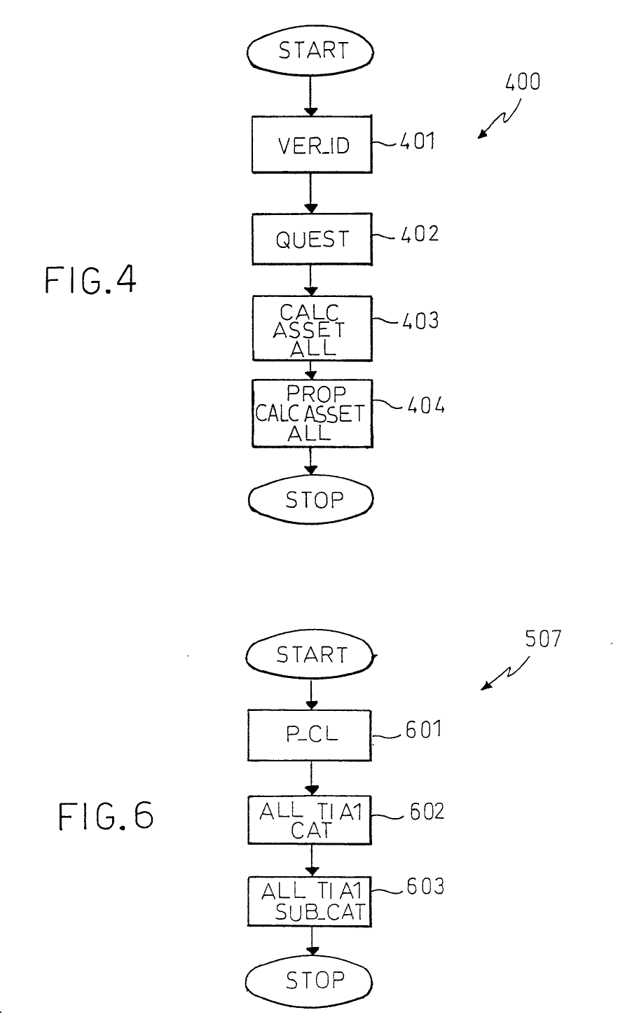

FIGS. 4, 5, 6 and 9 show, by means of flow charts, the main steps of the method according to the present invention,

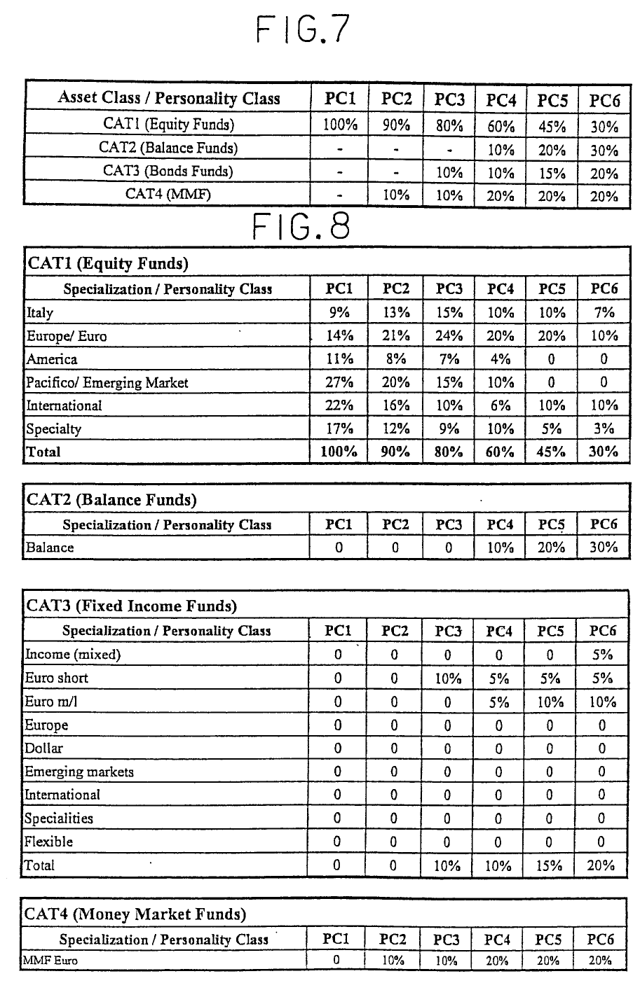

FIGS. 7 and 8 show, in table form, possible examples of the allocation of financial resources to categories and subcategories of mutual funds,

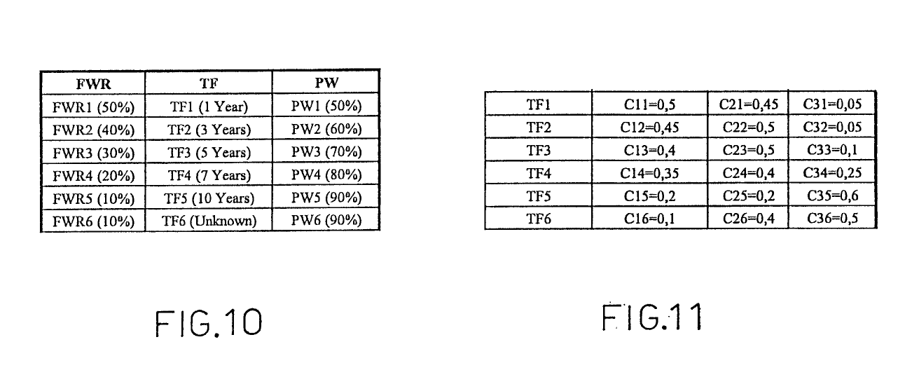

FIGS. 10 and 11 show, in table form, examples of values of parameters and coefficients used in the method according to the invention,

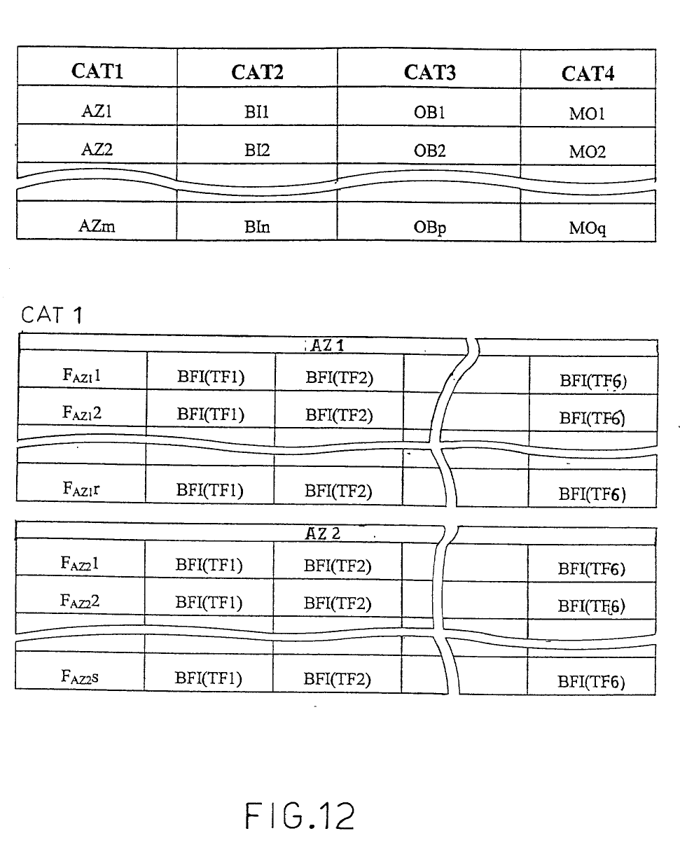

FIG. 12 shows, in table form, indicator parameters calculated in accordance with the method of the invention for establishing a personalized ranking of mutual funds for an investor,

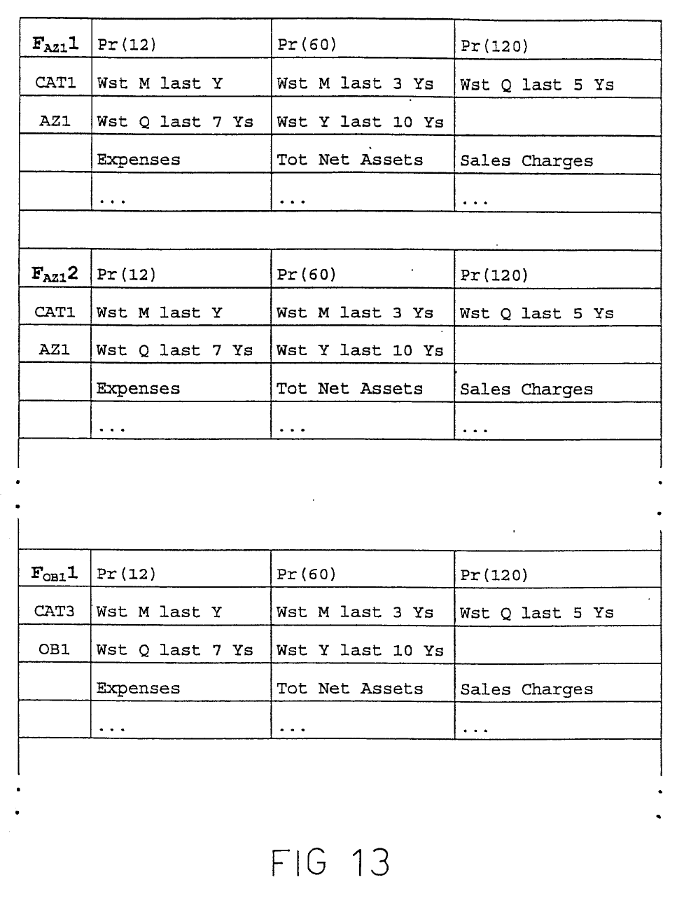

FIG. 13 shows, in table form, and at a simplified, schematic level, a database of mutual funds stored in the service provider's processing system, and

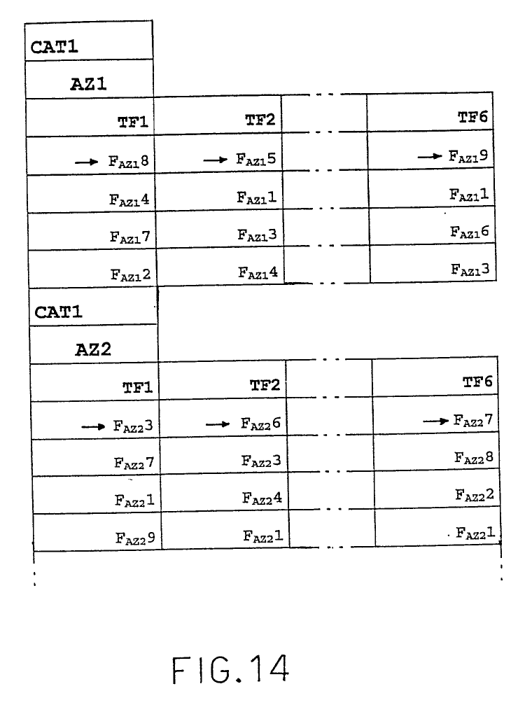

FIG. 14 shows, in table form and at a simplified, schematic level, a personalized ranking of mutual funds established on the basis of the method according to the invention.

With reference to the drawings and to FIG. 1 in particular, this shows, very schematically, a system 100 in which the present invention can advantageously be used. The system concerned comprises a telecommunication network 105, typically the Internet.

As is known, the Internet is a global network of processing systems with a decentralized structure. Within the Internet, the processing systems use a “client-server” architecture. As is known, a client-server architecture is an information network architecture in which each computer or process of the network behaves as a “client” or as a “server”.

The servers are computers having significant computational power or processes which are dedicated to the management of disc storage units (file servers), of printers (printing servers), or of network traffic (network servers).

The clients are personal computers or workstations on which the user can run the applications software. The clients rely on the servers to find the necessary resources such as, for example, files, devices, or even computational power.

The Internet provides for various protocols for communication between the clients and the servers. One particular protocol, which is known as the “World Wide Web” (“WWW”) or more simply the “Web” permits access to a subset of servers (known as web sites) which support a so-called hypertext document management system; the documents are also known as web pages. Each web page is constituted by a file in a particular format known as HTML (“hypertext mark-up language”) which permits hypertext links to other documents.

A server processing system 120 of a supplier of products and services according to the present invention is connected to the telecommunication network 105. The server processing system 120 constitutes a web site which is accessible to the client processing systems connected to the telecommunication network 105. Typically, some web pages of the web site 120 will be accessible without distinction to all of the client processing systems connected to the network, whereas some web pages of the site 120 will be accessible only to the client processing systems of users entitled or subscribing to the services offered by the web site 120.

In practice, the server processing system 120 will preferably comprise an outer (“front-end”) subsystem connected directly to the telecommunication network 105, and an inner (“back-end”) subsystem connected to the front-end subsystem by means of a dedicated line protected by suitable access barriers (“firewalls”) to prevent intrusion into the back-end subsystem from the network 105.

FIG. 1 also shown a user's client processing system 110, connected to the network 105. Typically, the user's client processing system 110 has access to the telecommunication network 105 by means of a respective network access provider (known on the Internet as an “Internet service provider”) not shown in the drawing. The client processing system 110 comprises a computer 110e, for example, a personal computer.

For simplicity of description, FIG. 1 shows only one server processing system 120 and only one client processing system 110; clearly, however, the system described above may be used by any number of server processing systems and client processing systems connected to the telecommunication network.

For example, further server processing systems from which the service and product provider's server processing system 120 can obtain data relating to the mutual funds, analyses of these data, etc., will be connected to the telecommunication network 105 (for simplicity, only one of these is shown, indicated 130 in FIG. 1). Amongst these further server systems will be, in particular, the server systems of the various companies which manage mutual funds, with which the product and service provider's server system 120 will be able to communicate in order to administer any orders issued by the users subscribing to the service for purchases or sales of shares in the mutual funds.

Similar considerations apply if the various processing systems are connected in a different manner, for example, by means of a public network of another type, or a geographical network (a “wide area network” or “WAN”), or if the user has a system based on a television set or a mobile telephone connected to the telecommunication network by means of a WAP protocol (a “wireless application protocol”).

FIG. 2 shows schematically the main components of the computer 110e of the client processing system 110. The computer 110e is constituted, for example, by a personal computer (a PC) comprising various units connected in parallel to a communication bus 205. In particular, a microprocessor (μP) 210 controls the operation of the computer 110e, a working memory 215, typically a DRAM (dynamic random access memory), is used directly by the microprocessor 210, and a read-only memory (ROM) 220 contains a basic (“bootstrap”) program for starting up the computer 110e.

Moreover, various peripheral units are connected to the bus 205 (by means of respective interfaces, not shown). In particular, a bulk memory consists of a hard disk 225, of a drive (DRV) for optical discs (CD-ROMs) 235, and of a drive (DRV) 240 for reading/writing floppy disks 245.

The computer 110e also comprises an input unit consisting of a keyboard 250 and a desktop pointing device (a “mouse”) 255, an output unit consisting of a monitor 260, a printer 265, and a MODEM (“MOdulator DEModulator”) 275 for connection to the telecommunication network 105.

Similar considerations apply if the computer has a different structure, for example, if it is constituted by a central unit to which various terminals are connected, or by a computer network, or if it has further units such as a sound card which controls loudspeakers, an optical scanning device (a “scanner”), a web video camera (a “web cam”), etc.

A structure similar to that described above with reference to the client processing system 110 can also be used, on a suitable scale, for the product and service provider's server processing system 120.

FIG. 3 shows, again in schematic form, a partial content of the working memory of the computer 110e of the client processing system 110 and of the server processing system 120 during their operation. The information (programs and data) is typically stored in the bulk memory and loaded (at least partially) into the working memory at the execution stage.

The computer 110e of the client processing system 110 includes, in addition to an operating system and various applications programs (not shown in the drawing), a driver module (M_DRV) 305 which physically controls the transmission of data on the telecommunication network 105 by means of the MODEM 275. The MODEM driver module 305 communicates with a browser module 310 for access to the web.

The server system 120 includes, in addition to an operating system and various administrative programs (not shown in the drawing), an engine (ENG) 320 for controlling communication with the telecommunication network 105. A plurality of web pages (WP) 323 are present in the bulk memory of the system; the web pages 323 are transmitted to the computer 110e by means of the telecommunication network 105, under the control of the engine 320. The engine 320 communicates with a control module 325 of an infrastructure for identifying authorized users operating, for example, on the basis of public and private encryption keys; this module 325 controls a database of users 330 stored in the bulk memory of the system 120. The engine 320 also communicates with a module (R_INFO) 340 which manages the acquisition of information transmitted by the user's client processing system 110 by means of the telecommunication network 105. The module 340 communicates with a module (IN_PR) 350 which deduces an investor profile of the user on the basis of the information acquired by the module 340. The module 350 communicates with a module (ALL) 360 which performs an allocation of the investor's financial resources (an “asset allocation”) to financial investment products, for example, a distribution of the financial resources in terms of categories and specializations within the categories of mutual funds, on the basis of the investor profile deduced by the module 350. The module 350 and the module 360 also communicate with a module (F_SEL) 370 which performs a personalized selection of financial investment products, for example, mutual funds, available on the market, on the basis of the investor profile deduced by the module 350, and of the asset allocation established by the module 360. In order to make the selection, the module 370 relies on a table (F_BFI_TAB) 380 suitably created by the server system 120 and stored in its memory. In order to create the table 380, a module (C_BFI) relies on a database of mutual funds (F_DB) 395 containing objective information relating to the mutual funds available on the market, with indications, for example, relating to the category to which they belong, to the specialization within the category, to performance over a plurality of time bases, and to other information. A schematic, tabular representation of the database 395 is given in FIG. 13. The database 395 may be constructed by the server system 120 by obtaining the necessary data from providers of financial information, either by means of the telecommunication network 105 or in another way. A table (C&S_TAB) 365 giving the categories and the specializations within the categories of the mutual funds available is also extrapolated from the database 395. A schematic representation of the table 365 is given in FIG. 12 (the upper table). The module 360 relies on the table 365 to perform the asset allocation in terms of categories and specializations within the categories of mutual funds.

In order to establish a personalized “asset allocation” for the investor, that is, to calculate the distribution of the investor's financial resources, the method 400 which is summarized by means of a flow chart in FIG. 4, and which will now be described, is followed.

First of all, the user, who will also be referred to without distinction as the investor, visits the web site of the server 120 by means of his own client processing system 110. The server's engine 320 transmits, by means of the network 105, a web page for entry to the site (a “home page”) which contains, in general, “links” to other web pages of the web site, represented concisely in the form of an index. These links are typically represented by “hot spots” in the web page displayed by the client computer 110e, which “hot spots” can be activated, for example, by means of the client computer's pointing device 255. One of the links, when activated by the user, leads to entry to the procedure which implements the method 400.

Preferably, when the user activates this link, a user identity checking procedure is first of all started in order to establish whether the user is entitled, that is, is a subscriber, to the service (VER_ID box 401). In order to do this, the user will have to transmit information which can be used to identify him, for example, a user identification code (a user ID) and a password, to the server processing system 120, by means of the telecommunication network 105. The module 325 relies on the database of users 330 in order to identify the user.

When the user's identity has been checked and it has been established that he/she is an investor subscribing to the service, the server 120 transmits to the client 110 a web page or, preferably, a sequence of web pages (QUEST box 402) which are displayed in succession upon request by the user. This sequence of web pages contains at least one questionnaire bearing questions relating to the investor, to which he/she replies by filling the web pages in suitable spaces. The questionnaires are filled in interactively by the investor with the use of the pointing device or the keyboard of the computer 110e.

By filling in the at least one questionnaire, that is, by replying to the questions contained therein, the investor provides the server system with subjective information which will be used to deduce an investor profile. This subjective information will be used in combination with the objective information stored in the database 395 of the server system in order to establish a personalized ranking of the financial investment products, for example, of the mutual funds available on the market, for the investor.

The at least one questionnaire is preferably subdivided into three questionnaires.

In particular, the first questionnaire bears questions which are drawn up in a manner suitable for enabling indications of the investor's life style to be deduced from his answers. A second questionnaire bears questions drawn up in a manner suitable for enabling personal information regarding the investor (“personal info”) to be derived from his replies. A third questionnaire bears questions drawn up in a manner suitable for establishing the investor's level of experience in financial investment matters, on the basis of his replies.

In particular, each of the three questionnaires comprises, amongst other things, at least one question which enables the server system to deduce an investment “time frame” for the investor.

The investor is obliged to answer the questions of the first questionnaire. However, the investor has the option to provide answers only to the first of the three questionnaires, skipping the remaining two, or to the first and to the second questionnaires, skipping the third, or to all three questionnaires. The three questionnaires are drawn up in a manner such that, if the user provides replies only to the first questionnaire, the server system 120 can already deduce an approximate investor profile by means of the module 350 whereas, if the user also provides replies to the second questionnaire, or even to all three questionnaires, the server system can deduce a more precise investor profile. In other words, the second and third questionnaires enable the server system to perform a “fine tuning” of the investor profile, particularly in relation to his time frame.

For example, in the first questionnaire relating to life style, the investor is asked:

a question to which the investor has to reply by stating the duration of the investment period which he/she would choose if he/she had what were estimated to be a considerable amount of capital to invest. The investor is guided in his reply to this question by a number of predetermined replies suggested by the questionnaire, for example: “one year”, “three years”, five years”, “seven years”, “ten years (or more)”, “don't know”; in the web page displayed by the client computer, an entry box is displayed beside each suggested reply and the investor enters his preselected reply by marking the entry box beside the selected reply, by means of the mouse;

a question to which the investor has to reply by stating how much time he/she requires to judge the quality of an investment; here again, the investor is guided in his reply by means of a number of predetermined replies suggested by the questionnaire which may be, for example, the same as those listed above; the investor enters the reply in the manner described above;

a question to which the investor has to reply by stating the degree of confidence which he/she places in his own selections; for example, the question is displayed explicitly in the web page and beneath it is displayed a cursor which can be moved along a graduated scale between a minimum value ( e.g. “0”) and a maximum value (e.g. “100”), by means of the pointing device. The investor can move the cursor, positioning it on the selected scale value;

other questions suitable for deducing the investor's life style.

In the second questionnaire relating to personal information, the investor is asked a question to which he/she must reply by stating when he/she expects that the capital which he/she intends to invest will have to be realized in whole or in part, to meet expenses. In the web page displayed by the client computer, two data-input windows are provided, one for the entry of the expected realization date, and one for the entry of the amount which is expected to have to be realized. Other questions suitable for enabling personal information relating to the investor to be deduced are also asked.

In the third questionnaire which relates to the investor's level of experience, the investor is asked:

a question to which the investor has to reply by stating how he/she interprets, in terms of absolute time, the statement “long term” used in the field of financial investments; several alternative replies are suggested to the investor: for example, “one year”, “three years”, “five years”, “seven years”, “ten years”, and a “don't know” reply is also allowed for; the investor enters the selected reply as in the first questionnaire;

a question to which the investor has to reply by stating the extent of his knowledge on the subject of financial investments; for example, the question is displayed in a web page and beneath it is displayed a cursor which can be moved along a graduated scale from a minimum value (“low”) to a maximum value (“high”) by means of the pointing device; the investor can move the cursor, positioning it at the selected point along the scale, by means of the pointing device;

other questions suitable for enabling the extent of the investor's experience in the subject of financial investments to be deduced.

The investor also provides the server with an indication of the total amount of the financial resources which he/she wishes to invest, as a reply to a question in the questionnaires, for example, in the first questionnaire.

When the investor has replied to the questions of a web page currently displayed, he/she causes the replies provided to be transmitted to the server 120 on the network 105 simultaneously with a request for the next web page in the sequence, by selecting a suitable “hot spot” on the web page; this process is repeated up to the last web page of the sequence.

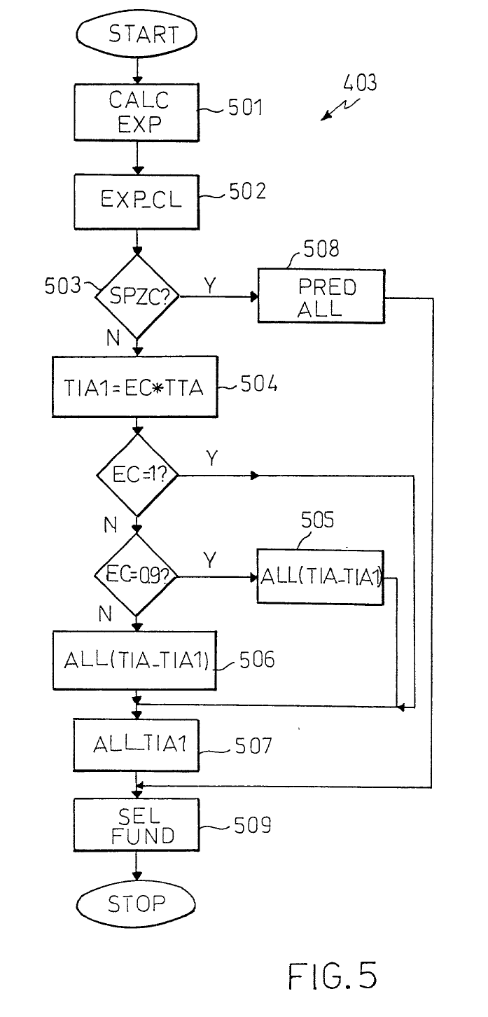

The server thus acquires information relating to the investor, that is, subjective information, to be set against the objective information which is stored in the database 395, and which will be used to calculate the personalized distribution of the investor's financial resources in shares of mutual funds. The distribution is calculated in accordance with the following method (CALC ASSET ALL box 403 in FIG. 4, detailed in FIG. 5).

First of all, on the basis of the replies provided by the investor to the questions of the questionnaire, the server system establishes a value for a correction parameter EC (“experience corrector”) which will subsequently be used in the calculation of the personalized distribution of the investor's financial resources. In particular, the value of the correction parameter EC is established as follows. First of all, the server system calculates the value of a parameter EXP (CALC_EXP box 501 in FIG. 5) on the basis of the investor's replies to the questions: a) extent of knowledge on the subject of financial investments, and b) degree of confidence which the investor places in his own selections.

A value for the EXP parameter within a range of permissible values which extends from 0 to 100 is thus obtained. For simplicity, the server may divide the range of permissible values for the EXP parameter into a discrete number of “experience categories” and then establish into which experience category the value of the EXP parameter calculated for the investor (EXP_CL box 502 in FIG. 5) falls. The plurality of experience categories may, for example, comprise three categories EXCL1, EXCL2, EXCL3; investors with high values of the EXP parameter, corresponding to a high level of experience (“experienced investor”) fall within the category EXCL1, investors with medium values of the EXP parameter, corresponding to a medium level of experience (“semi-experienced investor”) fall within the category EXCL2, and investors with low values of the EXP parameter, corresponding to a low level of experience (“novice investor”) fall within category EXCL3.

As will be described below, the method of calculating the distribution of the financial resources can deal with exceptions to the rule. This is the reason for the decision box 503 of FIG. 5 (SPEC?). For the moment, it is assumed that the decision box is left by the “N” branch, that is, it is assumed that no exception is involved.

For each of the experience categories, there is a corresponding respective value of the correction parameter EC. For example, for category EXCL1 EC=1, for category EXCL2 EC=0.9, and for category EXCL3 EC=0.8. The correction parameter EC is a multiplication factor which is applied to the total amount of the investable financial resources (the total investable assets) TIA, in order to establish a proportion TIA1 of the total investable assets TIA given by TIA1=TIA*EC (box 504 in FIG. 5).

The proportion TIA1 represents that portion of the investor's total investable assets TIA which will be used in the subsequent calculation of the personalized distribution. Thus, if the investor can be classified as experienced (TIA1=TIA*1=TIA), all of the investable assets will be allocated in the manner which will be described below; if the investor can be classified as semi-experienced (TIA1−TIA*0.9), only 90% of the investable assets will be allocated in the manner which will be described, whilst the remaining 10% of the investable assets TIA will be allocated, for example, to low-risk financial instruments such as, for example, money market funds (“MMFs”) (box 505 in FIG. 5); if the investor were to be classifiable as inexperienced, (TIA1−TIA*0.8), only 80% of the investable assets would be allocated in the manner which will be described and, of the remaining 20% of the investable assets TIA, 10% would be allocated, for example, to money market funds and 10% to short-term bond funds (box 506 in FIG. 5).

It should be noted that the foregoing represents purely an example of allocation. In general, a certain number of experience categories will be created, each category corresponding to a predetermined value of the correction factor EC, on the basis of which the proportion TIA1 of the total investable assets TIA and a predetermined allocation of the remainder (TIA−TIA1) of the investors assets will be calculated.

When the proportion TIA1 of the investor's assets has been calculated in dependence on his level of experience, its distribution is calculated (box 507 in FIG. 5, detailed in FIG. 6). With reference to FIG. 6, the calculation proceeds in the following manner.

First of all, the system establishes to which category of a plurality of personality categories the investor belongs, on the basis of the information provided by the investor in reply to the questions in the questionnaires, particularly the questionnaire relating to the investor's personality (box 601 in FIG. 6). Purely by way of example, with reference to the chart of FIG. 6, there are six personality categories PC1-PC6. For each of the six categories PC1-PC6, there is a corresponding given distribution of the proportion TIA1of the assets to be invested, calculated as described above, into various categories of mutual funds CAT1-CAT4 (box 602 in FIG. 6). The categories of mutual funds considered are, for example:

CAT1: stock mutual funds

CAT2: balanced mutual funds

CAT3: bond mutual funds

CAT4: money market mutual funds (MMFs)

An example of the allocation of the investor's investable assets TIA1 is given in the table of FIG. 7. It should be noted that the allocation given represents purely an example of an allocation which is in no way limiting. In general, on the basis of the replies provided by the investor to the questionnaires, a certain number of personality categories is created, to each of which a predetermined distribution of the assets to the various categories of mutual funds will correspond.

Again on the basis of the division into six personality categories PC1-PC6, the system establishes a sub-distribution (box 603 in FIG. 6) within the previous distribution, that is, a sub-distribution of the assets within the categories of mutual funds (stock mutual funds, balanced mutual funds, bond mutual funds, money market mutual funds). In fact, as is known, sub-categories grouping together mutual funds with various specializations can be defined within the subdivision into categories. For example, within the category of stock mutual funds, it is possible to identify stock mutual funds specializing in stocks quoted on the Italian market, or in stocks quoted on the markets of countries in the Euro region, or in stocks quoted on the markets of European countries, or on United States markets, etc.

An example of the sub-distribution is given in the table of FIG. 8. Once again, this is purely an example of the allocation of the investor's assets which is in no way limiting.

As mentioned above, the system may provide for one or more particular cases to be treated as exceptions to the allocation rule described above, which take account of particular investor profiles (decision box 503 in FIG. 5).

For example, if on the basis of the information supplied by the investor it appears that the investor has a recorded age above a particular predetermined value, for example, of 60 years, or is retired, or that the investor is a housewife, or that the total investable assets TIA are limited, that is, below a predetermined threshold value, or that the investor falls within experience category EXCL3 (inexperienced), the above-described method of calculating the allocation is not followed but the assets are allocated in accordance with a predetermined fixed scheme (PRED ALL box 508 in FIG. 5). For example, 50% of the assets will be allocated to balanced mutual funds, 20% to money market mutual funds, 10% to bond mutual funds specializing in international markets, 10% to so-called mixed (“mixed” or “income”) mutual bond funds, and 10% to stock mutual funds with international specialization.

The system has thus calculated the distribution of the investable assets into categories and subcategories of mutual funds. As is clear, the distribution is personalized according to the investor.

Again according to the present invention, the system then goes on to identify which of the mutual funds available on the market are best suited to the investor in question, within the scope of the distribution into categories and subcategories already calculated (SEL FUND box 509 in FIG. 5).

In fact, within the same generic subcategory of mutual funds, naturally the mutual funds of that subcategory vary relative to one another from many points of view. In selecting one mutual fund rather than another, many variables come into play, amongst which are: the level of reliability of the fund-management company to which the fund belongs, the total capital managed by the fund-management company, that is, the sum of the total capitals of all of the mutual funds managed by the fund-management company, the capability of the fund-management company, measured in terms of performance over a plurality of time bases (one year, three years, five years, . . . ), etc.

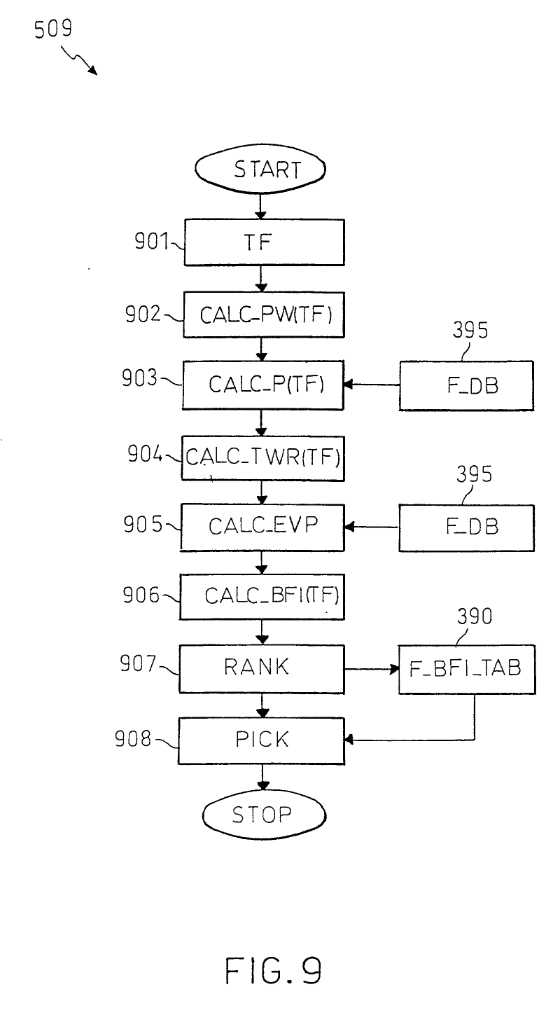

According to the present invention, the following criterion for the personalized selection of mutual funds to be suggested to the investor is proposed (reference is made to FIG. 9).

The criterion of personalized selection according to the present invention is based substantially upon the identification of the investor's so-called “time frame” (box 901 in FIG. 9) on the basis of the information provided by the investor in reply to the questions asked in the questionnaires.

The time frame is a parameter which defines objectively, and not subjectively, the investor's investment objectives with regard to time, in other words the period of time for which the investor expects to leave his assets invested. The server system deduces the time frame for the investor on the basis of his replies to the questions asked in the questionnaires, examples of which have been given above.

With reference to the table given in FIG. 10, the method provides for the definition of a plurality of time windows TF, for example, six time windows TF1-TF6. For. example, time window TF1 corresponds to a time frame of one year, time window TF2 corresponds to three years, time window TF3 corresponds to five years, time window TF4 corresponds to seven years, time window TF5 corresponds to ten years, and time window TF6 corresponds to a time frame not specified by the investor.

In dependence on the time window, the server system establishes (box 902 in FIG. 9) a weight factor PW (“performance weight”) which will be used as a multiplier for a respective parameter P1-P6 identifying the performance of the mutual fund. The weight factor PW may in fact adopt six different values PW1-PW6 depending on the time window to which it refers. Examples of values of the weight factors PW1-PW6 are given in brackets in the table of FIG. 10.

In order to calculate the parameter P1-P6 (box 902 in FIG. 9), according to the invention, a weighted average of the performance of the mutual funds over a plurality of time bases, in which the individual weight factors vary in dependence on the reference time window, is taken.

The database 395 of the server system 120 containing the objective data relating to all of the mutual funds available on the market, or at least to that subset of commercially available mutual funds which the service provider intends to handle, stores, amongst other things, information indicative of the performance of each mutual fund over a plurality of time bases.

For example, performance in the last twelve, sixty and one hundred and twenty months is taken into consideration. The weights attributed to the above-mentioned performance values in order to calculate a weighted mean thereof vary in dependence on the time window. In other words:

Pi=Pr(12)*C1i+Pr(60)*C2i +Pr(120)*C3i

where i is an index which can take the values 1, 2, . . . , 6, Pi is the weighted average of the performance values relating to the i-th time window, Pr(12), Pr(60) and Pr(120) are the performance values based on twelve, sixty and one hundred and twenty months, respectively, and C1i, C2i and C3i are eighteen weight factors, which are dependent on the time window, and which are used to calculate the weighted average.

Examples of values for the weight factors C1i, C2i and C3i are provided in the table given in FIG. 11. It is pointed out that, as the investment time frame increases, that is, going from the time window TF1 to the time window TF6, the weight attributed to performance over the shorter time bases decreases and that attributed to performance over longer time bases increases. In other words, as the time frame increases, the centre of weight is shifted towards performance over the longer time bases.

The performance of the individual mutual funds are not the only parameters which are taken into consideration in the method according to the present invention. In fact, for each individual mutual fund present in the database of the server system, a respective evaluation parameter EVP of the mutual fund is calculated (box 905 in FIG. 9), again weighted by a parameter FWR which is established by the server system (box 904 in FIG. 9) and the value FWR1-FWR6 of which depends on the time window TF1-TF6, in particular:

FWRi=1−Pi

In order to calculate the evaluation parameter, the server system proceeds in the following manner.

First of all, the evaluation parameter is calculated by adopting different criteria according to whether stock funds, bond funds or money-market funds are involved.

With regard to stock funds, the evaluation parameter of a given fund is created as a weighted mean of a plurality of indicators relating to the fund, which are stored in the database of the server system. Amongst the indicators used are, for example: the so-called “draw down” within the time window TF1-TF6 of interest, that is, that window into which the investor falls; the management costs deducted by the mutual-fund manager (the “expense ratio”); the level of concentration of the mutual fund capital in the main stocks present in the portfolio of the mutual fund (the “individual concentration”); the level of concentration of the mutual fund capital in the various sectors of the stock market (industrial, telecommunications, etc.) (the “branch concentration”); the position of the mutual fund in a ranking of funds of the same category drawn up in terms of the total capital managed by the mutual fund (the “total net asset rank”), the charges inflicted on the purchasers of shares by the fund, for example, the charges upon entry to/exit from the mutual fund (the “sales charges”).

The “draw down” indicator is calculated, as stated, on the basis of the reference time window, that is, the time window TF1-TF6 in which the inventor is situated. For the time windows TF1 and TF2, the worst performance on a monthly basis during the last year (“Wst M last Y” in FIG. 13), or in the last three years (“Wst M last 3 Ys” in FIG. 13) is taken into consideration, respectively; for the time windows TF3 and TF4, the worst performance on a three-monthly (“quartile”) basis in the last five years (“Wst Q last 5 Ys” in FIG. 13), or in the last seven years (“Wst Q last 7 Ys” in FIG. 13) is taken into consideration, respectively; for the time windows TF5 and TF6, the worst performance on an annual basis in the last ten years (“Wst Y last 10 Ys” in FIG. 13) is taken into consideration.

The server system creates tables giving rankings of the mutual funds in terms of the respective values of the “draw down” indicator, calculated in the manner indicated above. An index (a score) depending on whether the fund is situated amongst the best or the worst mutual funds in the ranking is thus attributed to each fund. For example, for simplicity, the ranking is divided into three bands: if the fund is in the top band of the ranking (for example, the band in which 20% of the funds, starting with the best, are situated) a high score will be attributed to it, if it is situated in the middle band (for example, of 60%), a medium score will be attributed to it, and if it is situated in the bottom band (for example, the last 20% of the mutual funds) a low score will be attributed to it.

With regard to the other indicators, that is, the “expense ratio”, the “individual concentration”, the “branch concentration”, the “total net asset rank” and the “sales charges”, the server system creates corresponding tables for each of these indicators, each table giving a ranking of the mutual funds on the basis of the respective indicator, and a score is attributed to each fund in dependence on its position in the ranking (in this case also, for simplicity, the ranking may be divided into bands, for example, three bands and a score may be attributed to the mutual fund in dependence on the band of the ranking in which it is situated).

With regard to bond and money market mutual funds, the evaluation parameter of the fund is again created as a weighted average of a plurality of indicators amongst which are: the “draw down”, the “expenses ratio”, the so-called “maturity” of the bond shares in the portfolio, the level of concentration in shares issued by the first three issuers in order of the presence of these shares in the portfolio (the “issuer concentration”), the position of the fund in a ranking of funds of that category drawn up in terms of the total capital of the fund (the “total net asset rank”) and the charges made to the investor (the “sales charges”).

For the mutual balanced funds, the FWR parameter is calculated with a criterion which takes account of the presence of both shares and bonds in the portfolios of these funds.

For each fund present in the database of the server system, a respective indicator parameter BFI (“best fit index”) depending on the time window TFi (i=1, 2, . . . 6) is thus created and is given by:

BFI(TFi)=FWRi(TFi)*K1(TFi)+PWi(TFi)*K2(TFi)

which, for a number of time windows TFi which, in the example considered, is equal to six, translates into six different values of the indicator parameter BFI (FIG. 12).

On the basis of the indicator parameter BFI calculated in the above-described manner, the server system can establish a ranking amongst mutual funds of the same category and with the same specialization within the category; this ranking is also personalized for the investor in the sense that it takes account of the investor's time frame. In practice, for each of the six time windows TF1-TF6 it is possible to establish a ranking amongst the mutual funds of a given category and with a given specialization within the category (RANK box 907 in FIG. 9). FIG. 14 shows a ranking of the mutual funds in table form and at a simplified, schematic level.

The parameter BFI is used by the server system in order to select which of the mutual funds amongst those commercially available, or amongst those that the service provider distributes, to suggest to the investor. In particular, with reference once more to the division and subdivision given in the tables of FIGS. 7 and 8 and already established in the manner described above, the selection of the particular mutual fund of a certain category and with a given specialization within the category is made by selecting the mutual fund which has the highest value of the BFI parameter in comparison with the other mutual funds of the same category and with the same specialization for the given time window in which the investor is situated (PICK box 908 in FIG. 9).

The server system can thus establish a composition for a portfolio of shares in mutual funds which is personalized for each investor on the basis of information provided by the investor himself.

The composition thus calculated can be suggested to the investor: the server system 120 transmits to the user's client processing system 110, by means of the engine 320 and the telecommunication network 105, the composition calculated on the basis of the answers to the at least one questionnaire provided by the user.

The investor can take various actions on the basis of the composition calculated and suggested to him. For example, if the calculated composition satisfies the investor, he/she can confirm the composition, sending an order to purchase shares in the suggested mutual funds to the server system, by means of the telecommunication network 105. Alternatively, the investor may compare the personalized composition of the portfolio calculated by the server system with a current composition of his own portfolio of shares in mutual funds. Naturally, some of the above-mentioned operations may require the investor subscribing to the service to have a current account with the provider of the service.

Clearly, variations and/or additions to the method and the system described and illustrated may be provided without thereby departing from the scope of protection of the invention defined in the appended claims.

For example, although in the detailed description provided, reference is always made to mutual funds, naturally, the present invention can also readily be applied to financial investment products of other types such as stocks, bonds, insurance policies, loans, etc. It will be clear to an expert in the art to apply to the above-described example the modifications suitable for rendering it applicable in practice to such further financial investment products.

1. A method of establishing a personalized ranking of financial investment products for an investor which provides for:
the provision of a database of available financial investment products in which, for each financial investment product, information relating at least to a type of the financial investment product, and to the performance of the financial investment product over a plurality of time bases, is stored,
the submission, to an investor, of at least one questionnaire with questions suitable at least for identifying an investment time frame of the investor,
the calculation of an indicator parameter for each financial investment product in the database, in which the calculation of the indicator parameter comprises the weighting of the performance of the financial investment product over the plurality of time bases with respective weight factors depending on the investor's investment time frame, and
the establishment of a ranking of the financial investment products of each type on the basis of the respective indicator parameters calculated.

2. A method according to claim 1, which provides for:
the definition of a discrete set of predetermined time windows;
the calculation of an indicator parameter for each of the windows of the discrete set, for each financial investment product in the database, and
the establishment of that time window of the predetermined time windows to which the investor's time frame belongs, on the basis of the replies provided by the investor to the questions in the least one questionnaire, so that the ranking of the financial investment products of each type is established on the basis of the indicator parameters corresponding to the predetermined time window within which the investor's investment time frame falls.

3. A method according to claim 2, in which the calculation of an indicator parameter for each of the time windows of the discrete set comprises:
the calculation of a weighted average of the performance of the financial investment product over the plurality of time bases with respective weight factors depending on the time window;
the calculation of an evaluation parameter of the financial investment product depending on further information relating to the financial investment product, other than its performance over the plurality of time bases, and stored in the database, and
the calculation of the indicator parameter as a weighted average of the weighted average of the performance and of the evaluation parameter, with respective weight factors depending on the time window.

4. A method of establishing a personalized composition of a portfolio of shares in mutual funds for an investor which provides for:
the provision of a database of available mutual funds in which, for each mutual fund, information relating at least to a category to which the mutual fund belongs, and to the performance of the mutual fund over a plurality of time bases, is stored,
the submission, to an investor, of at least one questionnaire with questions suitable at least for identifying an investment time frame of the investor;
the calculation of an indicator parameter for each mutual fund of the database, in which the calculation of the indicator parameter comprises the weighting of the performance of the mutual fund over the plurality of time bases with respective weight factors depending on the investor's investment time frame,
the establishment of a ranking of the mutual funds of each category on the basis of the respective indicator parameters calculated, and
on the basis of replies provided by the investor to the questions, the calculation of a distribution of the investable assets amongst the categories of mutual funds and, within each category, the establishment of a sub-distribution to at least one mutual fund of that category,
in which the selection of the at least one mutual fund within a given category is made on the basis of the ranking of the mutual funds of that category.

5. A method according to claim 4, which also provides for the suggestion of the distribution and of the sub-distribution of the investable financial resources to the investor.

6. A method according to claim 4, which provides for:
the definition of a discrete set of predetermined time windows;
the calculation of an indicator parameter for each of the time windows of the discrete set, for each mutual fund in the database, and
the establishment of that time window of the predetermined time windows to which the investor's time frame belongs, on the basis of the replies provided by the investor to the questions of the at least one questionnaire, so that the ranking of mutual funds of each category is established on the basis of the indicator parameters corresponding to the predetermined time window within which the investor's investment time frame falls.

7. A method according to claim 6, in which the calculation of an indicator parameter for each of the time windows of the discrete set comprises:
the calculation of a weighted average of the performance of the mutual fund over the plurality of time bases with respective weight factors depending on the time window,
the calculation of an evaluation parameter of the mutual fund depending on further information relating to the mutual fund, other than its performance over the plurality of time bases, and stored in the database, and
the calculation of the indicator parameter as a weighted average of the weighted mean of the performance and of the evaluation parameter, with respective weight factors depending on the time window.

8. A method according to claim 4, in which the at least one questionnaire contains questions suitable for establishing a degree of experience of the investor on the basis of replies provided by the investor, and the calculation of a distribution of the investable financial resources amongst the categories of mutual funds comprises:
the calculation of a fraction of the investor's investable financial resources, the fraction depending on the investor's degree of experience, and
the calculation of a distribution of the fraction of financial resources amongst the categories of mutual funds in dependence on the investor's degree of experience.

9. A method according to claim 8, in which the establishment of the investor's degree of experience comprises:
the definition of a discrete set of predefined experience categories,
the establishment of that category of the predefined experience categories to which the investor's degree of experience belongs,
and in which the calculation of a distribution of the fraction of financial resources amongst the categories of mutual funds in dependence on the investor's degree of experience (EXP) comprises the calculation of the distribution in dependence on the experience category to which the investor's degree of experience belongs.

10. An interactive method of establishing a personalized ranking of financial investment products for an investor within a telecommunication network architecture of the client-server type which provides:
under the control of a service provider's server system:
for the provision of a database of available financial investment products, in which, for each financial investment product, information relating at least to a type of financial product, and to the performance of the financial investment product over a plurality of time bases, is stored,
for the provision of at least one questionnaire with questions suitable at least for identifying an investment time frame of an investor, and
upon request by an investor's client system, for the transmission of the at least one questionnaire to the client system,
under the control of the client system:
for the display of the at least one questionnaire to the investor,
for the acceptance of replies entered by the investor to the questions of the at least one questionnaire,
for the transmission to the server system of the replies entered by the investor, and
under the control of the server system:
for the interpretation of the replies entered by the investor,
for the identification of an investment time frame of the investor on the basis of the replies interpreted,
for the calculation of an indicator parameter for each financial investment product in the database, in which the calculation of the indicator parameter comprises the weighting of the performance of the financial investment product over the plurality of time bases with respective weight factors depending on the investor's investment time frame, and
for the establishment of a ranking of the financial investment products of each type on the basis of the respective indicator parameters calculated.

11. A method according to claim 10 which provides:
under the control of the server system (120):
for the definition of a discrete set of predetermined time windows,
for the calculation of an indicator parameter for each of the time windows of the discrete set, for each financial investment product in the database, and
for the establishment of that time window of the predetermined time windows to which the investor's investment time frame belongs, so that the ranking of financial investment products of each type is established on the basis of the indicator parameters corresponding to the predetermined time window in which the investor's investment time frame falls.

12. A method according to claim 10, in which the calculation of an indicator parameter for each of the time windows of the discrete set comprises:
under the control of the server system:
the calculation of a weighted average of the performance of the financial investment product over the plurality of time bases with respective weight factors depending on the time window,
the calculation of an evaluation parameter of the financial investment product depending on further information relating to the financial investment product, other than its performance over the plurality of time bases, and stored in the database, and
the calculation of the indicator parameter as a weighted average of the weighted average of the performance and of the evaluation parameter, with respective weight factors depending on the time window.

13. An interactive method of establishing a personalized composition of a portfolio of shares in mutual funds for an investor within a telecommunication network architecture of the client-server type, which provides:
under the control of a service provider's server system:
for the provision of a database of available mutual funds in which, for each mutual fund, information relating at least to the category to which the mutual fund belongs, and to its performance over a plurality of time bases, is stored, the database being accessible to the server system,
for the provision of at least one questionnaire with questions suitable at least for identifying an investment time frame of an investor, and
upon request by an investor's client system, for the transmission of the at least one questionnaire to the client system,
under the control of the client system:
for the display of the at least one questionnaire to the investor,
for the acceptance of replies entered by the investor,
for the transmission to the server system of the replies entered by the investor, and
under the control of the server system:
for the interpretation of the replies entered by the investor,
for the identification of a profile of the investor on the basis of the replies interpreted, the investor profile comprising at least one time frame of the investor,
for the calculation of an indicator parameter for each mutual fund in the database, in which the calculation of the indicator parameter comprises the weighting of the performance of the mutual fund over the plurality of time bases with respective weight factors depending on the investor's time frame,
for the establishment of a ranking of the mutual funds of each category on the basis of the respective indicator parameters calculated, and
for the calculation, on the basis of the investor's profile, of a distribution of the investable financial resources amongst the categories of mutual funds and, within each category, for the establishment of a sub-distribution to at least one mutual fund of that category,
in which the selection of the at least one mutual fund within a given category is made on the basis of the ranking of the mutual funds of that category.

14. A method according to claim 13 which also provides:
under the control of the server system, for the transmission of the personalized allocation calculated to the client system, and
under the control of the client system, for the display to the investor of the personalized allocation calculated.

15. A method according to claim 13 which provides:
under the control of the system server:
for the definition of a discrete set of predetermined time windows,
for the calculation of an indicator parameter for each of the time windows of the discrete set, for each mutual fund in the database, and
for the establishment of that time window of the predetermined time windows to which the investor's investment time frame belongs, so that the ranking of mutual funds of each category is established on the basis of the indicator parameters corresponding to the predetermined time window to which the investor's investment time frame belongs.

16. A method according to claim 15, in which the calculation of an indicator parameter for each of the time windows of the discrete set comprises:
under the control of the server system:
the calculation of a weighted average of the performance of the mutual fund over the plurality of time bases with respective weight factors depending on the time window,
the calculation of an evaluation parameter of the mutual fund depending on further information relating to the mutual fund, other than its performance over the plurality of time bases, and stored in the database, and
the calculation of the indicator parameter as a weighted average of the weighted average of the performance and of the evaluation parameter, with respective weight factors depending on the time window.

17. A method according to claim 13, in which the at least one questionnaire contains questions suitable for establishing a degree of experience of the investor, on the basis of the replies provided by the investor, and the calculation of a distribution of the investable financial resources amongst the mutual fund categories comprises:
under the control of the server system:
the calculation of a fraction of the investor's investable financial resources, the fraction depending on the investor's degree of experience, and
the calculation of a distribution of the fraction of financial resources amongst the mutual fund categories in dependence on the investor's degree of experience.

18. A method according to claim 17, in which the establishment of the investor's degree of experience comprises:
under the control of the server system:
the definition of a discrete set of predefined experience categories, and
the establishment of that category of the predefined experience categories to which the investor's degree of experience belongs,
and in which the calculation of a distribution of the fraction of financial resources amongst the mutual fund categories in dependence on the investor's degree of experience comprises, under the control of the server system, the calculation of the distribution in dependence on the experience category to which the investor's degree of experience belongs.

19. A computer program which can be loaded directly into a working memory of a server processing system in order to implement the steps of the method according to any one of claims 10 to 12, under the control of the server system when the program is run on the server processing system.

20. A computer program product comprising a substrate which can be read by a computer, on which substrate the program according to claim 19 is stored.

21. A computer program which can be loaded directly into a working memory of a server processing system in order to implement the steps of the method according to any one of claims 13 to 18 under the control of the server system when the program is run on the server processing system.

22. A computer program product comprising a substrate which can be read by a computer, on which substrate the program according to claim 21 is stored.

23. A data-processing system for establishing a personalized ranking of financial investment products for an investor, comprising:
data-processing means,
data-storage means,
a database of available financial investment products, stored in the storage means, in which, for each financial investment product, information relating at least to a type of the financial investment product, and to its performance over a plurality of time bases is stored,
first means for submitting to an investor at least one questionnaire with questions suitable at least for identifying an investment time frame of the investor and for collecting replies to the questions from the investor,
second means for interpreting the investor's replies and for identifying the investor's investment time frame,
third means for calculating an indicator parameter for each financial investment product in the database, in which the calculation comprises the weighting of the performance of the financial investment product over the plurality of time bases with respective weight factors depending on the investor's time frame, and
fourth means for establishing a ranking of the financial investment products of each type on the basis of the respective indicator parameters calculated by the third means.

24. A data-processing system for establishing a personalized composition of a portfolio of shares in mutual funds for an investor, comprising:
data-processing means,
data-storage means,
a database of available mutual funds, stored in the storage means, in which, for each mutual fund, information relating at least to the category to which the mutual fund belongs, and to its performance over a plurality of time bases, is stored,
first means for submitting to an investor at least one questionnaire with questions suitable at least for identifying an investment time frame of the investor and for collecting replies to the questions from the investor,
second means for interpreting the investor's replies and for identifying an investor profile, the profile comprising at least the investor's time frame,
third means for calculating an indicator parameter for each mutual fund in the database, in which the calculation comprises the weighting of the performance of the mutual fund over the plurality of time bases with respective weight factors depending on the investor's investment time frame,
fourth means for establishing a ranking of mutual funds of each category on the basis of the respective indicator parameters calculated by the third means, and
fifth means for calculating, on the basis of the investor profile, a personalized allocation of the financial resources to be invested, with a distribution amongst the categories of mutual funds and, within each category, suggesting a sub-distribution to at least one mutual fund of that category, in which the selection of the at least one mutual fund within a given category is made on the basis of the ranking of mutual funds of that category.

25. A data-processing system according to claim 23 or claim 24, in which the data-processing system is a server system operatively connected to a client system of the investor.
